(19) United States
(12) Patent Application Publication
(10) Pub. No.: US 2018/0025266 A1
(43) Pub. Date: Jan. 25, 2018

(54) READING APPARATUS

(71) Applicant: TOSHIBA TEC KABUSHIKI KAISHA, TOKYO (JP)

(72) Inventor: Wataru SAKURAI, IZU SHIZUOKA (JP)

(21) Appl. No.: 15/632,645

(22) Filed: Jun. 26, 2017

(30) Foreign Application Priority Data
Jul. 22, 2016 (JP) 2016-144411

(51) Int. Cl. G06K 19/07; G06K 7/00; G06K 7/10

(52) U.S. Cl. CPC G06K 19/0723; G06K 7/10316; G06K 7/0008; G06K 19/0701; G06K 7/10019; G06K 7/10217

(57) ABSTRACT

A reading apparatus for reading a wireless tag, such as an RFID tag, comprises a housing having a chamber and an opening providing an entrance to the chamber. A door attached to the housing and covers the opening when closed and permits access to the chamber when opened. A detector is proximate to a first portion of the housing and is configured to detect whether the door is opened or closed. The first portion of the housing faces the door when the door is closed. An antenna within the housing is configured to emit a radio wave to read information from wireless tags inside the chamber. A shielding portion is disposed adjacent to the detector to prevent the radio wave emitted by the antenna from leaking to the outside of the housing through the first portion of the housing.

This application is based upon and claims the benefit of priority from Japanese Patent Application No. 2016-144411, filed Jul. 22, 2016, the entire contents of which are incorporated herein by reference.

### FIELD

Embodiments described herein relate generally to a reading apparatus.

### BACKGROUND

In the related art, there is a reading apparatus which reads information stored in an RFID tag. This apparatus can be used for various purposes and provided in various forms. For example, there is a reading apparatus that may read an RFID tag placed in a storage container that has a side wall or side walls covered with radio wave absorbing material so only the RFID tag within the storage container is read by the reader. The tag information is read by the reading apparatus through an antenna that is provided proximate to or in a table on which the storage container is placed or mounted.

However, in the above described configuration in the related art, when the position of the storage container is not fully aligned with the antenna, an RFID tag outside of the storage container may respond to a radio wave transmitted by the antenna to the outside of the storage container. Therefore, there exists a configuration in which the antenna (or amounting table including the antenna) is placed in a housing having radio wave absorbing walls or the like, a range to which radio waves from the antenna is thus limited to the inside of the housing. The housing can include a door or the like to permit items to be placed in the housing then enclosed inside the housing. In this configuration, it is possible to control the starting and stopping of reading the RFID tags using the open/close states of the door by providing a detecting unit which detects the opening or closing of the door. In general, the detecting unit is located at or near a portion of the housing which is in contact with, or is close to the door, when the door is in a closed state. The detecting unit can include a mechanical switch or an optical sensor, for example.

However, generally, the detecting unit requires a hole or the like to be provided in the housing for detecting of the opening or closing of the door. This hole in the housing may permit radio waves to leak from the housing through the hole or the like.

### BRIEF DESCRIPTION OF THE DRAWINGS

FIG. 1 is an external perspective view of a document reading apparatus according to a first embodiment.

FIGS. 2A and 2B are external perspective views of a reading unit according to the first embodiment.

FIG. 3 is a schematic diagram of an opening-closing detecting mechanism according to the first embodiment.

FIG. 4 is a block diagram of a main body unit and a reading unit according to the first embodiment.

FIG. 5 is a block diagram of a main body unit and a reading unit according to the first embodiment.

FIG. 6 is a flowchart of an operation of a main body unit and a reading unit according to the first embodiment.

FIG. 7 is an external perspective view of a reading unit according to a second embodiment.

FIG. 8 is a schematic diagram of an opening-closing detecting mechanism according to the second embodiment.

FIG. 9 is a schematic diagram of an opening-closing detecting mechanism according to the second embodiment.

FIG. 10 is an external perspective view of a reading unit according to a third embodiment.

FIG. 11 is a schematic diagram of an opening-closing detecting mechanism according to the third embodiment.

### DETAILED DESCRIPTION

In general, according to one embodiment, a reading apparatus for reading a wireless tag, such as an RFID tag or the like, comprises a housing. The housing has a chamber and an opening providing an entrance to the chamber. A door is attached to the housing and it can cover the opening when closed and permit access to the chamber when opened. A detector is proximate to a first portion of the housing. The detector is configured to detect whether the door is opened or closed. The first portion of the housing faces the door when the door is closed. An antenna within the housing is configured to emit a radio wave to read information from a wireless tag or tags placed inside the chamber. A shielding portion is disposed adjacent to the detector to prevent the radio wave emitted by the antenna from leaking to the outside of the housing through the first portion of the housing.

### First Embodiment

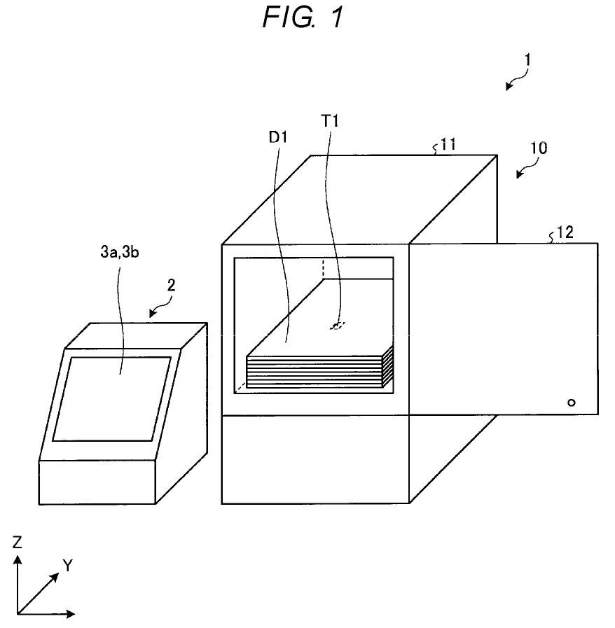

FIG. 1 illustrates an external perspective view of a document reading apparatus 1 according to a first embodiment. The document reading apparatus 1 reads a radio frequency identifier (RFID) tag T1 which is attached to a document D1 such as a billing statement, an admission ticket, a book, a driver's license, a passport, or any document. Here, the document reading apparatus 1 is provided on a desk, or the like. FIG. 1 illustrates a reading unit 10 with the door 12 open.

The document reading apparatus 1 is provided with a main body unit 2, and the reading unit 10 (e.g., reader-writer device). The main body unit 2 is provided with a display 3b and a touch panel 3a on the front face of the display 3b. As the display 3b, for example, a liquid crystal display is used.

The reading unit 10 is a reader-writer device which can read information from a RFID tag T1, which is attached to the document D1, or write data into the RFID tag T1. The RFID tag T1 stores information such as a document code which identifies the document D1 to which the RFID tag T1 is attached.

The reading unit 10 is connected to the main body unit 2 using a cable (not illustrated), or the like. The reading unit 10 outputs (sends) various information such as the document code, which has been read from the RFID tag T1, to the main body unit 2 in a wired or wireless manner. In addition, the main body unit 2 and the reading unit 10 are separate units. However, in some embodiments, the main body 2 and the reading unit 10 may be integrated (integrally formed).

Each RFID tag T1 is provided with a storage medium for writing a registered flag, which will be described later. The presence or absence of the registered flag can be checked by a gate sensor at an entrance to the document reading apparatus 1, and a warning can be made using a notification unit such as a buzzer when an RFID tag with no registered flag is placed in the document reading apparatus 1.

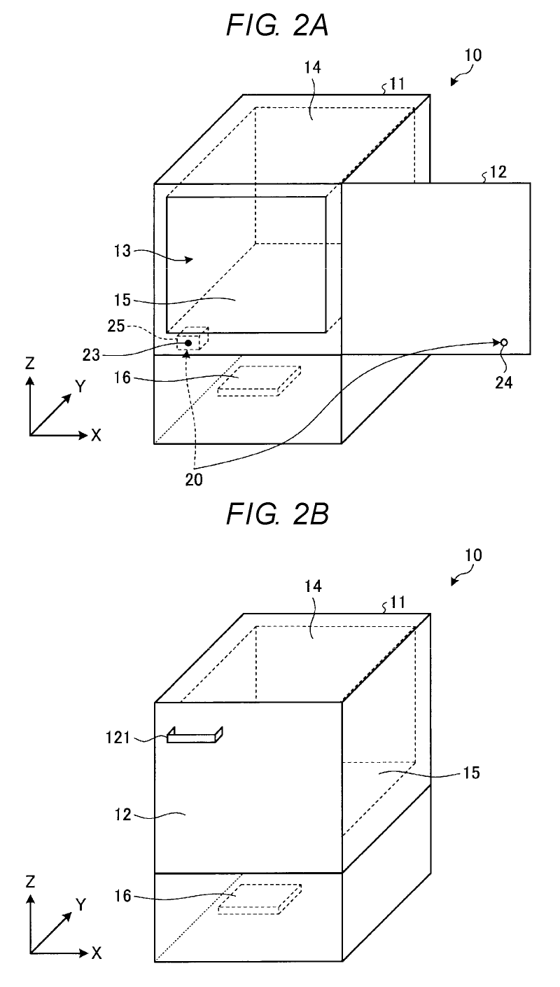

FIGS. 2A and 2B illustrate external perspective views of the reading unit 10. FIG. 2A illustrates the reading unit 10 with the door 12 open, and FIG. 2B illustrates the reading unit 10 with the door 12 closed.

An exterior of the reading unit 10 includes the housing 11, the walls of which form the exterior of the reading unit 10, and the door 12. One of the walls of the housing 11 has an opening portion 13, and the door 12 opens or closes the opening portion 13. The wall of housing 11 including the opening portion 13 is referred to as “first wall” and the walls of housing 11 not including an opening portion are referred to as “second walls.” The housing 11 is formed in a box-like shape, has a depth (e.g., Y-direction) which is larger than a width (e.g., X-direction). The housing 11 may be provided integrally with the main body unit 2, and/or may be detachable from the main body unit 2.

The door 12 is attached so as to be opened or closed using a hinge (not specifically illustrated) on the right front face of the main body unit 2. The door 12 opens or closes the opening portion 13 to a storage chamber 14. An opening-closing lever 121 is attached to the door 12. A user opens or closes the door 12 by holding the opening-closing lever 121.

The opening portion 13 is has a size through which a plurality of documents D1 can pass simultaneously. The storage chamber 14 inside of the housing 11 can accommodate the plurality of documents D1. A user can insert the document D1 inside of the storage chamber 14 or extract the document D1 from the storage chamber 14 through the opening portion 13 of the first wall of the housing 11, when the door 12 is open. In addition, the document D1 may be within a storage container, which is formed of an insulating member such as wood or glass, when placed inside the storage chamber 14.

In the storage chamber 14, the document D1 is mounted, or placed, on a mounting surface 15 at a base of the storage chamber 14. The mounting surface 15 is made of a plate-shaped insulating material such as wood or glass, and is supported at a fixed distance from the base of the housing 11. Inner wall surfaces of the storage chamber 14, excluding the mounting surface 15, are made of a radio wave reflecting material, for example, a well-known and common radio wave reflecting material, such as metal, or ferrite.

In addition, a planar RFID antenna 16, a circuit board (not specifically illustrated), and the like, are provided between the mounting surface 15 and the base of the housing 11. The RFID antenna 16 communicates with the RFID tag T1 attached to each document D1 in the storage chamber 14 by outputting a radio wave in the UHF band, or the like. The RFID antenna 16 outputs a radio wave when the door 12 is closed in cooperation with a reader-writer unit 41, which will be described later.

Inner facing walls of storage chamber 14 and the door 12 are formed of radio wave reflecting or absorbing material (s) to prevent radio waves from leaking out of the housing 11 (in particular, storage chamber 14), or stray or unintended radio waves from outside of housing 11 from permeating into the housing 11, in particular storage chamber 14.

It is possible to use common radio wave reflecting materials, such as metal or ferrite, or a radio wave absorbing material, for shielding portions of the housing 11.

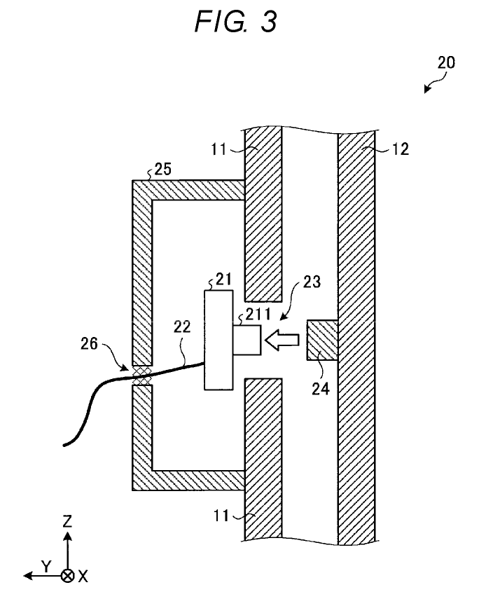

An opening-closing detecting mechanism 20 for detecting the state of the door 12 is provided at a portion of the housing 11 which is in contact with, or is close to, the door 12 when in a closed state. More specifically, a portion of the opening-closing detecting mechanism 20 is provided at an edge portion of the housing 11 which contacts the closed door 12 and another portion of the opening-closing detecting mechanism 20 is provided on a portion of the door 12 which faces the edge portion when door 12 is closed. Hereinafter, a configuration of the opening-closing detecting mechanism 20 will be described with reference to FIGS. 2A and 3.

FIG. 3 is a schematic diagram of an opening-closing detecting mechanism 20 Here, FIG. 3 illustrates a partial cross-sectional view in which the opening-closing detecting mechanism 20 is viewed in along X direction as depicted in FIGS. 2A and 2B.

As illustrated in FIG. 3, the opening-closing detecting mechanism 20 is provided with a switch 21 which serves as a detector for detecting an opening-closing state of the door 12. The switch 21 is a mechanical switch which senses a momentary action, such as a push switch or a tactile switch. The switch 21 is provided inside the housing 11, and is connected to a circuit board using a wire harness 22. In addition, a hole 23, with a size determined by the size of a pushing portion 211 of the switch 21, is provided in the housing 11 facing the switch 21.

A projection portion 24 is a protrusion on a wall of the door 12 at a portion of facing the hole 23 when the door 12 is in a closed state. The projection portion 24 has a diameter smaller than the hole 23, and a height which allows the projection portion 24 to push the pushing portion 211 of the switch 21 when the door 12 is closed.

As depicted in FIG. 3, when the door 12 is closed, the projection portion 24 12 moves in an arrow direction (left-page direction), and the switch 21 is switched (switch closed) by the pushing portion 211 engaging with the projection portion 24 through the hole 23. In addition, when the door 12 is opened, the projection portion 24 of the door 12 moves in the right-page direction (opposite direction to the arrow direction in FIG. 3), and the switch 21 is switched (switch opened) when the pushing portion 211 is released by retrograde movement of the projection portion. The switch 21 thus detects the opened/closed state of the door 12 based on the switching of ON/OFF caused by the projection portion 24. Specifically, the switch 21 outputs a signal denoting a closed state of the door 12 to the circuit board through the wire harness 22 when the pushing portion 211 is initially depressed by projection portion 24. In addition, the switch 21 outputs a signal denoting an open state of the door 12 to the circuit board through the wire harness 22 based when the pushing portion 211 is released from a depressed position.

There is a possibility that a radio wave from the RFID antenna 16 may leak out of the housing 11 through the hole 23. In addition, there is a possibility that a radio wave from outside of the housing 11 may permeate into the housing 11 through the hole 23. Such leakage or permeation of radio wave can cause an error in reading of the RFID tag T1, malfunction, or the like, between the reading apparatus and any other reading apparatus nearby.

Therefore, the opening-closing detecting mechanism 20 is provided with a shielding portion where the switch 21 is provided. The shielding portion prevents radio wave leaks from inside of housing 11 and radio waves from outside of housing 11 from permeating into the housing 11.

Specifically, the opening-closing detecting mechanism 20 is provided with a cover portion 25 which covers the switch 21, the hole 23, and the surrounding thereof as a shielding portion. The cover portion 25 is made of a radio wave reflecting material or a radio wave absorbing material, and is connected to an inner wall of the housing 11 by screwing, welding, or the like, without a gap. In FIG. 3 (and FIG. 2A) the cover portion 25 is box-shaped. However, in some embodiments, the cover portion 25 is dome-shaped, or the like.

The wire harness 22 passes through a hole 26 provided in the cover portion 25. The size of the hole 26 is not particularly important and may be determined by, for example, a diameter of the wire harness 22. It is generally preferable that an space between the wire harness 22 and the hole 26 be filled with a conductive material having a radio wave (more generally, electromagnetic) shielding property, such as a metallic mesh, porous metal, or the like. In this manner, it is possible to prevent a radio wave from leaking through the hole 26.

In the reading unit 10 in the above described configuration, a user can collectively read the RFID tags T1 which are attached to the different documents D1 placed in the storage chamber 14. In addition, with this configuration, it is possible to suppress erroneous operations such as those in which a document D1 is extracted or added during the middle of a reading operation since the storage chamber 14 is isolated from the user by a closed door 12 and reading via RFID antenna 16 can be set to occur only when door 12 is closed.

It is possible to prevent radio waves from leaking into or out of the housing 11 by covering the inner surfaces of the storage chamber 14 with a radio wave reflecting material and also covering certain outer surfaces of the reading unit 10 (e.g., housing 11 and door 12) with a radio wave reflecting or absorbing material. Furthermore, the periphery of the switch 21 and the hole 23 can be shielded against leakage using a cover portion 25 that is formed of a radio wave reflecting or absorbing.

Since a radio wave transmitted by the RFID antenna 16 can be limited to inside of the housing 11 in the reading unit 10, it is possible to prevent a radio wave from inside of the housing 11 from having any influence on a RFID tag T1 outside of the housing 11. In addition, since the storage chamber 14 can be shielded from a radio wave from outside of the housing 11, erroneous reading of the RFID tags T1 inside of the housing can be prevented.

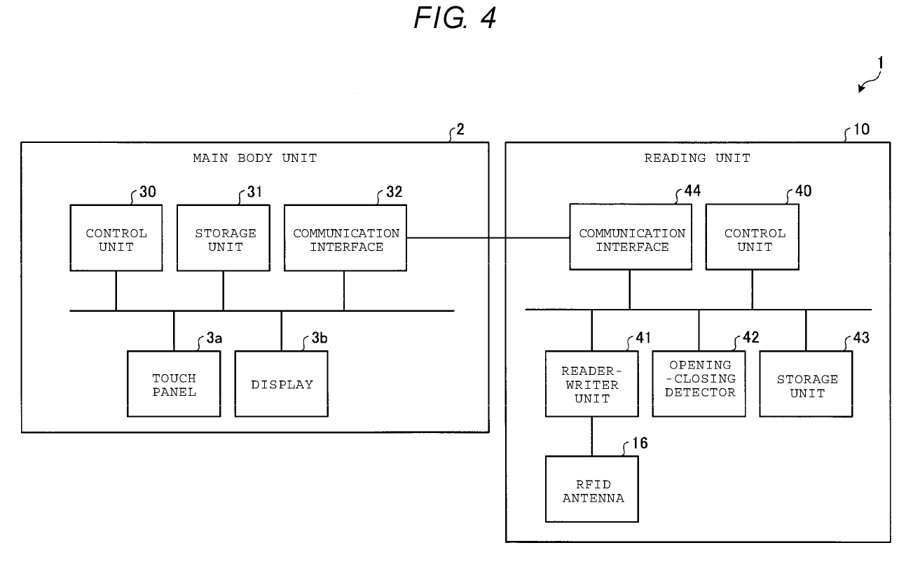

FIG. 4 illustrates a block diagram of the main body unit 2 and the reading unit 10.

The main body unit 2 has a control unit 30 with a central processing unit (CPU), a read only memory (ROM), a random access memory (RAM), and the like. The ROM stores various programs and various data which are executed by the CPU. The RAM temporarily stores data or a program when the CPU executes various programs. The control unit 30 may be a computer.

A touch panel 3a and a display 3b are connected to the control unit 30 through various input-output circuits (not illustrated).

In addition, a storage unit 31, a communication interface 32, and the like, are connected to the control unit 30 through various input-output circuits (not illustrated).

The storage unit 31 is implemented by a non-volatile storage medium such as a hard disk drive (HDD) and a solid state drive (SSD). The storage unit 31 stores various programs or various data which are related to an operation of the main body unit 2. In addition, the storage unit 31 stores a document code which is read by the reading unit 10. The storage unit 31 may store a data table (hereinafter, referred to as “table”) such as a database of document codes or user information, or the like, correlated to documents D1. The communication interface 32 sends and receives various data to and from the reading unit 10.

The reading unit 10 is provided with a control unit 40, which is implemented by a CPU, a ROM, a RAM, and the like. The ROM stores various programs and various data which the CPU executes. The RAM temporarily stores data or a program when the CPU executes various programs.

In addition, a reader-writer unit 41, an opening-closing detector 42, a storage unit 43, a communication interface 44, and the like, are connected to the control unit 40 through various input-output circuits (not illustrated).

The reader-writer unit 41 is implemented by a RFID reader/writer device and drives the RFID antenna 16 to transmit a modulated radio wave for reading and writing the RFID tag T1. The reader-writer unit 41 outputs various information (for example, document code, or the like), which are read from the RFID tag T1 through the RFID antenna 16, to the control unit 40. In addition, the reader-writer unit 41 transmits information in association with the RFID tag T1, to be written on the RFID tag T1 (for example, flag information, or the like) through the RFID antenna 16 to the RFID tag T1.

The opening-closing detector 42 comprises the switch 21, which detects an opening-closing state of the door 12. A detection result of the opening-closing detector 42 is output to the control unit 40. The storage unit 43 is implemented by a non-volatile storage medium such as an HDD, an SSD, or the like. The storage unit 43 stores various programs or various data which are related to an operation of the reading unit 10. The communication interface 44 sends and receives various data to and from the main body unit 2. In addition, the control unit 40, the reader-writer unit 41, the storage unit 43, and the communication interface 44 which are provided in the reading unit 10 are mounted on a circuit board (not illustrated).

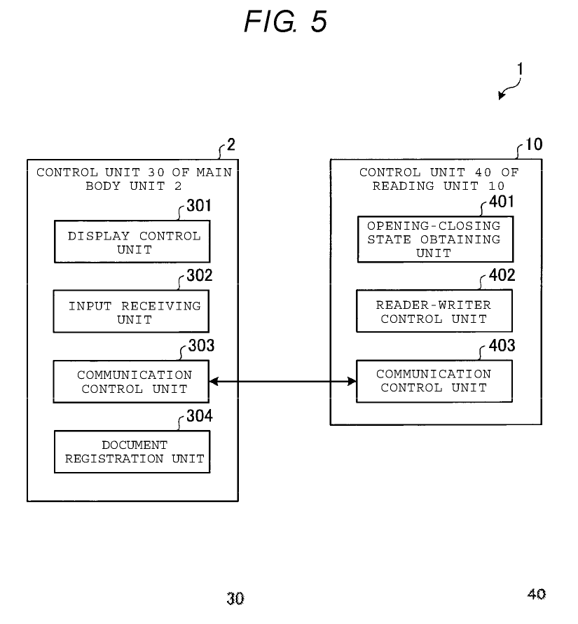

FIG. 5 illustrates a block diagram of the control unit 30 of the main body unit 2 and the control unit 40 of the reading unit 10.

The control unit 30 (e.g., CPU) of the main body unit 2 causes a display control unit 301, an input receiving unit 302, a communication control unit 303, and a document registration unit 304 to perform functions in accordance with a program stored in the storage unit 31.

The display control unit 301 controls and causes the display 3b to display various screens. For example, the display control unit 301 causes the display 3b to display a screen to receive instructions, such as a start of reading of a document code (e.g., RFID tag T1) (hereinafter, referred to as “start button for reading”), and an end of reading (hereinafter, referred to as “ending button for reading”). When a table is stored in the storage unit 31, the display control unit 301 may read information in association with a document code which is sent from the reading unit 10, and causes the display 3b to display the information.

The input receiving unit 302 receives an input through the touch panel 3a. For example, when a button or icon is pressed (a touching operation) on a screen which is displayed on the display 3b, the input receiving unit 302 outputs instruction information corresponding to the touching operation to the control unit 30.

The communication control unit 303 controls the communication interface 32, and sends and receives information to and from the reading unit 10 through the communication interface 32. For example, when the start button for reading is operated, the communication control unit 303 instructs the reading unit 10 to start reading. In addition, the communication control unit 303 receives a document code which is sent from the reading unit 10. When the ending button for reading is operated, the communication control unit instructs the reading unit 10 to end reading. For example, when a sales registration by the document registration unit 304 is completed, the communication control unit 303 notifies the reading unit 10 of a completion of the registration.

The document registration unit 304 registers a document code, which is sent from the reading unit 10, in a predetermined region of the storage unit 31. Specifically, the document registration unit 304 registers the document code received by the communication control unit 303 in a storage region (for example, database, or the like), together with a date of reception. In addition, the storage region for registration may be an external device which can communicate with the main body unit 2.

The control unit 40 (e.g., CPU) of the reading unit 10 causes an opening-closing state obtaining unit 401, a reader-writer control unit 402, and a communication control unit 403 to perform functions in accordance with a program stored in the storage unit 43.

The opening-closing state obtaining unit 401 obtains opening-closing state information (whether the door 12 is open or closed), detected by the opening-closing detector 42.

The reader-writer control unit 402 performs reads an RFID tag T1 which is attached to a document D1, and controls the reader-writer unit 41 to write information in association with the RFID tag T1.

Specifically, when an external instruction to start reading is received from the document reading apparatus 1, and opening-closing state information obtained by the opening-closing state obtaining unit 401 indicates the door is closed, the reader-writer control unit 402 starts reading.

When an external instruction to end reading is received from the main body unit 2, the reader-writer control unit 402 instructs the reader-writer unit 41 to end reading. In addition, when a completion of a registration is notified from the main body unit 2, the reader-writer control unit 402 controls the reader-writer unit 41, and starts writing a registered flag in a storage medium included in the RFID tag T1. Here, the registered flag indicates a completion of a document registration.

In addition, when the door 12 opens between a start of reading of the RFID tag T1 and writing of the registered flag, the reader-writer control unit 402 ends reading, and resets a document code which has been read. The reader-writer control unit 402 also resets a document code which has been sent to the document reading apparatus 1 and registered. In addition, the reader-writer control unit 402 re-starts reading the RFID tag T1, when the door 12 is determined to be closed.

In this manner, it is possible to reliably read a document D1 in the storage chamber 14 even when a document D1 is extracted from the storage chamber 14, or when a document D1 is added to the storage chamber 14, before writing of the registered flag. In addition, a screen for notifying of an open state of the door 12 can be displayed on the display 3b by notifying the main body unit 2 of the open state of the door 12.

The communication control unit 403 controls the communication interface 44, and sends and receives information to and from the main body unit 2. For example, the communication control unit 403 receives instruction to start reading, which is sent from the main body unit 2. In addition, the communication control unit 403 sends a document code, which the reader-writer control unit 402 reads from the RFID tag T1, to the main body unit 2. The communication control unit 403 receives instruction to end reading, which is sent from the main body unit 2. In addition, the communication control unit 403 receives notification of a completion of a registration, which is sent from the main body unit 2.

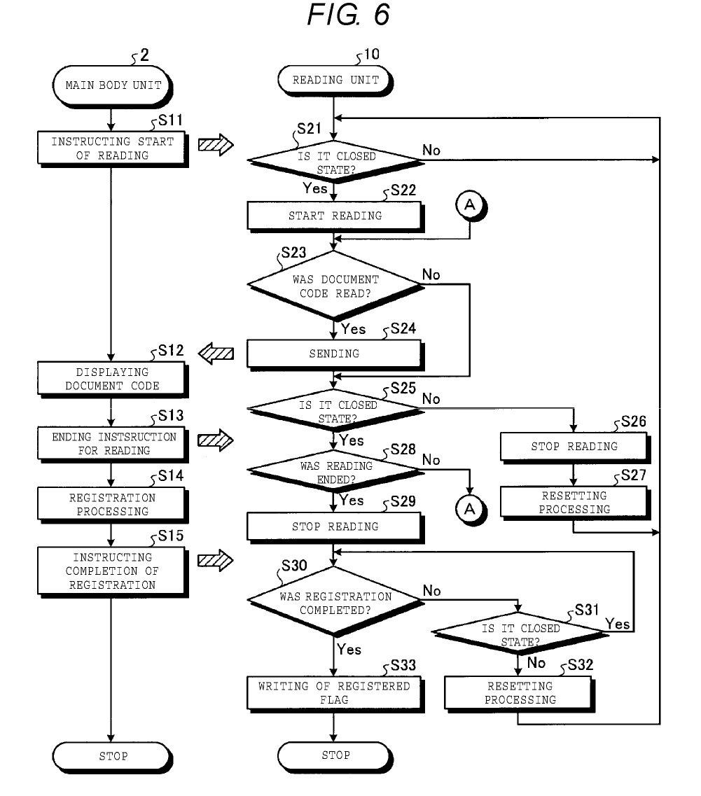

FIG. 6 is a flowchart of an operation of the main body unit 2 and the reading unit 10.

A user who uses the document reading apparatus 1 opens the door 12, and inserts a document D1 in the storage chamber 14. Subsequently, when the user operates the start button for reading on the display 3b 2, the process starts.

In the main body unit 2, when the input receiving unit 302 receives the input for starting reading (via operation of the start button), the communication control unit 303 sends instruction to start reading to the reading unit 10 (step S11).

In the reading unit 10, when the communication control unit 403 receives instruction to start reading, the reader-writer control unit 402 determines whether or not the door 12 is closed, based on opening-closing state information which is obtained by the opening-closing state obtaining unit 401 (step S21). Here, the reader-writer control unit 402 stands by until the door 12 is determined to be closed (No in step S21), when the door 12 is determined to be open. In addition, the reader-writer control unit 402 may causes the display control unit 301 of the main body unit 2 to display a screen for urging the user to close the door 12 during standby in step S21.

When the door 12 is determined to be closed (Yes in step S21) in step S21, the reader-writer control unit 402 starts reading the RFID tag T1 (step S22). Subsequently, the reader-writer unit 41 determines whether or not a document code is read from the RFID tag T1 (step S23). Here, when the document code has not been read (No in step S23), the process proceeds to step S25.

In addition, when the document code is read (Yes in step S23), the communication control unit 403 sequentially sends the document code (step S24) to the main body unit 2, and the process proceeds to step S25.

In the subsequent step S25, the reader-writer control unit 402 determines whether or not the door 12 is closed, based on opening-closing information which is obtained by the opening-closing state obtaining unit 401 (step S25). When the door is determined to be open (No in step S25), the reader-writer control unit 402 stops reading the RFID tag T1 (step S26). In addition, the reader-writer control unit 402 resets a document code which has been read (step S27), and the process returns to step S21. The reader-writer control unit 402 also resets a document code which has been sent to the main body unit 2, and registered.

In addition, when the door is determined to be closed in step S25 (Yes in step S25), the reader-writer control unit 402 determines whether or not an instruction to end reading is received from the main body unit 2 (step S28). Here, when there is no instruction to end reading received (No in step S28), the process returns to step S23.

When reading of the RFID tag T1 is started when the storage chamber 14 is empty, a loop of No in step S23; Yes in step S25; and No in step S28 is continued so long as no RFID tag T1 is read at all. Therefore, after a predetermined time is passed (for example, 5 seconds), or the above described loop has been executed for a predetermined times without any RFID tag T1 being read, the reading process may be forcibly ended, in order to avoid such a continuous state. In addition, in such a case, the reader-writer control unit 402 may cause a message denoting that it is not possible to read any RFID tag T1 to be displayed by cooperating with the display control unit 301.

In the main body unit 2, when the communication control unit 303 receives a document code from the reading unit 10, the display control unit 301 displays the document code on the display 3b (step S12).

A user who operates the main body unit 2 refers to the document code which is displayed on the display 3b, and operates the ending button for reading on the display 3b, when confirming that document codes of all of the documents D1 in the storage chamber 14 are displayed. In addition, when the input receiving unit 302 receives the operation of the ending button for reading, the communication control unit 303 sends instruction to end reading to the reading unit 10 (step S13).

In the reading unit 10, when the communication control unit 403 receives instruction information to end reading, the reader-writer control unit 402 determines that an instruction to end reading is received (Yes in step S28). Subsequently, the reader-writer control unit 402 stops reading the RFID tag T1 (step S29).

Subsequently, the reader-writer control unit 402 determines whether or not a completion of a registration is notified from the main body unit 2 (step S30). When there is no notification of a completion of a registration (No in step S30) received, the reader-writer control unit 402 determines whether or not the door 12 is closed, based on the opening-closing state information which is obtained by the opening-closing state obtaining unit 401 (step S31).

Here, when the door is determined to be closed (Yes in step S31), the process returns to step S30. In addition, when the door is determined to be open (No in step S31), the reader-writer control unit 402 performs the same resetting processing as that in step S27 (step S32), and the process returns to step S21.

In the main body unit 2, the document registration unit 304 registers each document code which is displayed (step S14). In addition, the communication control unit 303 sends notification of a completion of a registration to the reading unit 10 (step S15), and ends the process.

In the reading unit 10, when the communication control unit 403 receives notification of a completion of a registration, the reader-writer control unit 402 determines that the completion of the registration is notified (Yes in step S30). In addition, the reader-writer control unit 402 controls the reader reader-writer unit 41 to write a registered flag in the RFID tag T1 of each document D1 (step S33), and ends the process.

The reader-writer control unit 402 may cause the display control unit 301 to display a screen indicating the door 12 is still closed while writing the registered flag. In addition, the reader-writer control unit 402 may cause the display control unit 301 to display a screen urging a user to open the door 12 after writing of the registered flag has been completed.

As described above, when a plurality of documents D1 in the storage chamber 14, the reading unit 10 can collectively read the RFID tags T1 attached to the documents D1 with the door 12 closed to isolate the documents D1 from user (s). The reading unit 10 can also more accurately read the RFID tag T1, since it is possible to limit the range to which radio waves from the RFID antenna 16 extends to inside of the housing 11.

### Second Embodiment

In the first embodiment, the switch 21 is used as the opening-closing detector 42. In the second embodiment, an optical sensor is used as the opening-closing detector 42. In addition, when included, the same reference numerals are given to the same elements as those described in conjunction with the first embodiment, and descriptions thereof will be omitted.

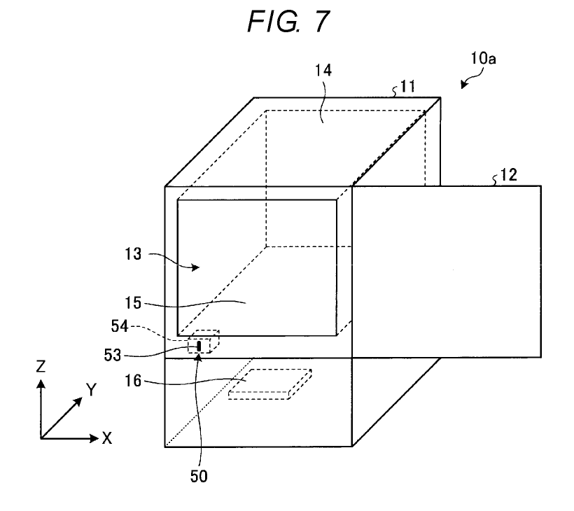

FIG. 7 illustrates an external perspective view of a reading unit 10a, according to the second embodiment, with the door 12 open. In addition, the reading unit 10a with the door 12 closed is the same as that illustrated in FIG. 2B.

As illustrated in FIG. 7, an opening-closing detecting mechanism 50 is provided at an edge portion of the housing 11, which is in contact with, or is close to the door 12 when the door 12 is closed. Hereinafter, a configuration of the opening-closing detecting mechanism 50 will be described with reference to FIGS. 7, 8, and 9.

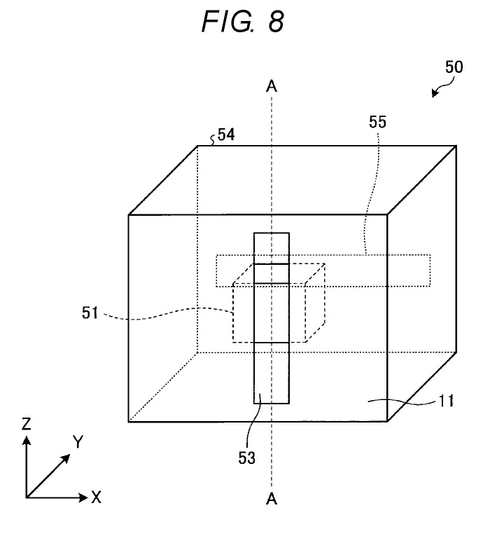

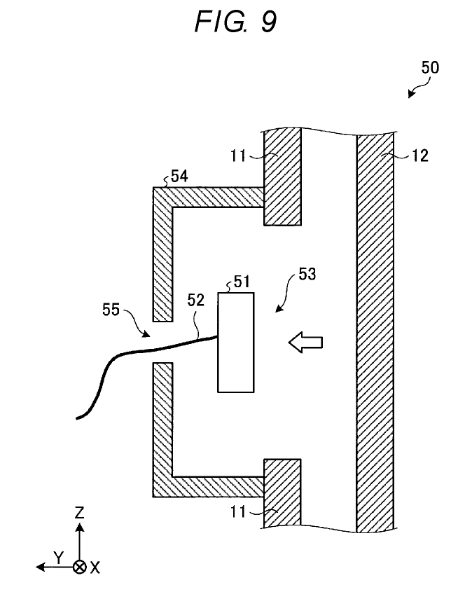

FIGS. 8 and 9 illustrate schematic diagrams of the opening-closing detecting mechanism 50. Here, FIG. 8 illustrates a partial perspective view in which the opening-closing detecting mechanism 50 is viewed in the Y direction of FIG. 7. In addition, FIG. 9 illustrates a partial cross-sectional view taken along line A-A in FIG. 8 in which the opening-closing detecting mechanism 50 is viewed from the X direction in FIG. 7. In FIG. 8, a wall surface of the housing 11 which is located on a front face side of the opening-closing detecting mechanism 50 is illustrated using a rectangular shape corresponding to a shape of the opening-closing detecting mechanism 50.

As illustrated in FIGS. 8 and 9, the opening-closing detecting mechanism 50 is provided with an optical sensor 51 as the opening-closing detector 42 for detecting an opening-closing state of the door 12. The optical sensor 51 includes an optical detector such as a photodiode, for example. The optical sensor 51 is provided inside the housing 11, and is connected to a circuit board (not specifically illustrated) through a wire harness 52 (illustrated in FIG. 9). In addition, a slit-shaped or elongated hole 53 for receiving light from outside is provided at the edge portion of the housing 11 facing the optical sensor 51.

When the door 12 closes, the door 12 moves in a direction as shown by an arrow in FIG. 9 (from page-right to page-left) and covers the hole 53, thereby blocking light from the outside from reaching the optical sensor 51 (dark state). When the door 12 opens, the door 12 moves in the opposite direction (from page-left to page-right) and uncovers the hole 53, thereby allowing light from outside into the optical sensor 51 (bright state). The optical sensor 51 detects an opening-closing state of the door 12 based on switching between bright states and dark states which are associated with movement of the door 12. Specifically, the optical sensor 51 outputs a signal to the circuit board through the wire harness 52 denoting the door is closed 12 when the optical sensor 51 is changed from bright to dark state. In addition, the optical sensor 51 outputs a signal denoting the door 12 is open when the optical sensor 51 changes from dark to bright.

There is a possibility that a radio wave from the RFID antenna 16 may leak in to or out of the housing 11 through the hole 53 of the housing 11. Such leakage in to or out of the reading unit 10a may cause an error in reading of the RFID tag T1, malfunction, or the like, between the reading apparatus and any other adjacent reading apparatus.

Therefore, the hole 53 is covered by a cover portion 54, provided inside of the housing, which shields a radio wave from leaking out of the housing 11, and a radio wave from permeating into the housing from outside of the housing 11.

Specifically, the opening-closing detecting mechanism 50 is provided with the cover portion 54 which covers the optical sensor 51, the hole 53, and the surrounding thereof as a shielding portion. The cover portion 54 is made of a radio wave reflecting material or a radio wave absorbing material, and is directly connected to the inner wall surface of the housing 11 by screwing, welding, or the like, without a gap. In addition, in FIGS. 8 and 9, the cover portion 54 is box-shaped. However, in some embodiments, the cover portion 54 is dome-shaped, or the like.

The wire harness 22 passes through a hole 55 provided in the cover portion 54. Here, a size of the hole 55 may be determined by, for example, a diameter of the wire harness 52. In such a case, it is preferable that any space between the wire harness 22 and the hole 55 be filled with a conductive material which blocks radio waves. In this manner, it is possible to prevent radio waves from leaking or passing through the hole 55.

As illustrated in FIGS. 8 and 9, both the holes 53 and 55 may be slit-shaped holes (e.g., slots). However, when this arrangement is adopted, it is preferable for the long dimensions of holes 53 and 55 to be orthogonal to each other when viewed from the front direction (from the Y direction in FIG. 8). It is also possible to for the holes 53 and 55 to function as polarizing filters which filter out vertically polarized radio waves and horizontally polarized radio waves Thus, it is possible to reduce the leakage of polarized radio waves with this arrangement.

It is preferable to set a size or a shape of the holes 53 and 55 in conjunction with the characteristics (e.g., wavelength) of the radio wave(s) output by the RFID antenna 16 so as to reduce possible leakage. In addition, it is preferable to set the shape and size of any space which might be formed by the housing 11 and the cover portion 54 in conjunction with the characteristics (e.g., wavelength) of the radio wave(s) output by the RFID antenna 16.

In this example, the hole 53 appears to be a cavity (an absence of any material; however, in other examples a film, a sheet, or the like, having a light-transmitting property (referred to as a “light-transmitting film”) may be attached to, cover, or fill the hole 53. In such a case, it is preferable to use a material having a radio wave absorbing property or otherwise a radio wave attenuating property for the light-transmitting film. Thus, it is possible to reduce any radio wave leakage occurring through hole 53.

### Third Embodiment

Subsequently, a third embodiment will be described. In the third embodiment, a magnetic sensor is used as the opening-closing detector 42. In addition, the same reference numerals are given to the same elements repeated from the first embodiment, and descriptions thereof will be omitted.

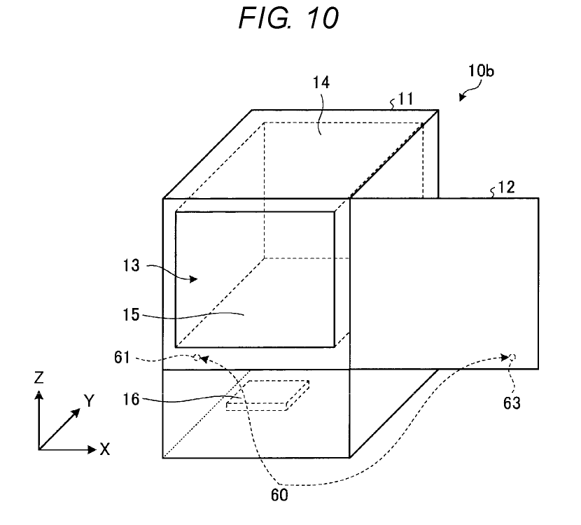

FIG. 10 illustrates an external perspective view of a reading unit 10b according to the third embodiment, with the door 12 of the reading unit 10b open. In addition, the reading unit 10b with the door 12 closed is the same illustrated in FIG. 2B.

As illustrated in FIG. 10, an opening-closing detecting mechanism 60 for detecting an opening-closing state of the door 12 is provided at a portion of the housing 11 which is in contact with, or proximate to the door 12 when in a closed state. More specifically, the opening-closing detecting mechanism 60 with the magnetic sensor 61 disposed at the edge portion of the housing 11, contacts, or nearly contacts, the door 12 when closed, and the magnet 63 disposed in or on a portion of the door 12 which faces the edge portion when closed.

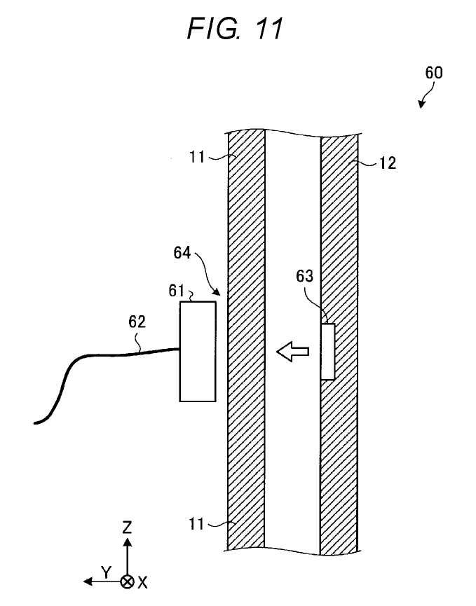

FIG. 11 illustrates a schematic diagram of the opening-closing detecting mechanism 60 viewed in the Y-Z plane in FIG. 10.

As illustrated in FIG. 11, the opening-closing detecting mechanism 60 is provided as the opening-closing detector 42 to detect a state of the door 12. The magnetic sensor 61 in the opening-closing mechanism 60 is a sensor element such as a coil, a Hall element, or the like, for example, which detects a magnitude of, or changes in, a magnetic field. The magnetic sensor 61 is provided inside the housing 11, and is connected to a circuit board (not illustrated) through the wire harness 62. A magnet 63 is embedded in the door 12 at a position which faces the magnetic sensor 61 when the door 12 is closed.

When the door 12 closes, the magnet 63 moves in a direction shown by an arrow in FIG. 11 (from right to left), and the magnetic field strength from the magnet 63 increases at the magnetic sensor 61 when the magnet 63 approaches. When the door 12 is opened, the magnet 63 embedded moves away from the magnetic sensor 61 and the magnetic field strength at the magnetic sensor 61 decreases. The magnetic sensor 61 thus detects whether door 12 is opened or closed based on changes in magnetic field caused by movement of magnet 63. Specifically, the magnetic sensor 61 outputs a signal denoting the door 12 is closed through the wire harness 62 when measured magnetic field reaches a predetermined first level. In addition, the magnetic sensor 61 outputs a signal denoting the door 12 is open through the wire harness 62 when the magnitude of a magnetic field reaches a predetermined second level, which is less than the predetermined first level).

The opening-closing detecting mechanism 60 includes a shielding portion proximate to the magnetic sensor 61 to which block radio waves which might leak into or out of the housing 11 at a portion at which the magnetic sensor 61 is provided. Specifically, here the shielding portion corresponds to a wall surface 64 of the housing 11 facing the magnetic sensor 61.

In the opening-closing detecting mechanism 60 according to the third embodiment, the front face of the magnetic sensor 61 is blocked by the wall surface 64 and there is sensor-related opening formed in the housing 11. Accordingly, in the reading unit 10b in the third embodiment, it is possible to prevent leakage of radio waves into or out of the housing 11 at the portion at which the magnetic sensor 61 is provided.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In the above described example embodiments, the portion of the housing 11 at which the opening-closing detector 42 (which may be any one of switch 21, optical sensor 51, and magnetic sensor 61) is an edge portion of the housing 11 that is under the mounting surface 15; however, embodiments are not limited to this example arrangement. Specifically, the location for the opening-closing detector 42 can be any portion of the housing 11 which contacts, or approaches contact with, the door 12 when the door 12 is in a closed state, and the location may be set to one or more edge portions on the upper part, or on the right and left sides of the housing 11.

In addition, in the above described example embodiments, reading of the RFID tag T1 starts according to a specific instruction from a user. However, reading of the RFID tag T1 may automatically start when the door 12 is closed, without specific instruction from a user.

In the above described embodiments, reading ends, and resetting starts when the door 12 opens between a start of reading of the RFID tag T1 and writing of a registered flag (e.g., when the door 12 opens during an on-going or incomplete reading-writing process). However, a locking mechanism for holding (locking) the door 12 closed may be provided at a contacting location between the housing 11 and the door 12. The door 12 can be controlled so as not to be openable until the reading-process is completed. Specifically, the door 12 is held closed between the starting of reading and the completion of the writing of the registered flag by a locking mechanism controlled by the reader-writer control unit 402. In this manner, it is possible to prevent a document D1 being extracted from the storage chamber 14 without full completion of writing of the registered flag, or a new document D1 being added into the storage chamber 14 at an improper time.

In the above described example embodiments, the reading of RFID tags T1 is ended according to an ending instruction from a user; however, possible embodiments are not limited to this. For example, the user may input a total number of RFID tags T1 to be read and the reading can be automatically ended when the number of RFID tags T1 that have been read equals the total number input value by the user.

In the above described embodiments, the reading unit 10 reads an RFID tag attached to a document. However, an RFID tag may be attached to any other object.

What is claimed is:

1. A reading apparatus for reading a wireless tag, the reading apparatus comprising:
a housing having a chamber and an opening providing an entrance to the chamber;
a door attached to the housing and covering the opening when closed and permitting access to the chamber when opened;
a detector disposed proximate to a first portion of the housing and configured to detect whether the door is opened or closed, the first portion of the housing facing the door when the door is closed;
an antenna within the housing and configured to emit a radio wave to read information from a wireless tag inside the chamber; and
a shielding portion disposed adjacent to the detector to prevent the radio wave emitted by the antenna from leaking to the outside of the housing through the first portion of the housing.

2. The reading apparatus according to claim 1, wherein the shielding portion comprises a radio wave reflecting material.

3. The reading apparatus according to claim 1, wherein the shielding portion comprising a radio wave absorbing material.

4. The reading apparatus according to claim 1, wherein at least a portion of the detector is disposed between the shielding portion and the first portion of the housing.

5. The reading apparatus according to claim 4, wherein
the shielding portion includes an opening therein, and
a wire connected to the detector passes through the opening in the shielding portion.

6. The reading apparatus according to claim 5, wherein a space between the wire and the shielding portion is filled with radio wave absorbing material.

7. The reading apparatus according to claim 1, wherein
the detector includes a mechanical switch,
the first portion of the housing has a first hole therein, and
the door includes a protrusion that depresses the mechanical switch through the first hole when the door is closed and releases the mechanical switch when the door is opened.

8. The reading apparatus according to claim 1, wherein
the detector includes an optical sensor,
the first portion of the housing has a first hole therein, and the optical sensor is positioned to receive light through the first hole when the door is opened, and the door, when closed, substantially blocks light from outside of the housing from reaching the optical sensor through the first hole.

9. The reading apparatus according to claim 1, wherein
the detector includes a magnetic sensor adjacent to the first portion of the housing,
the door includes a magnet positioned to be proximate to the magnetic sensor when the door is closed and distal from the magnetic sensor when the door is open, and
the shielding portion comprises at least one of radio wave absorbing material or radio wave reflecting material covering the first portion of the housing.

10. The reading apparatus according to claim 1, wherein the wireless tag is an RFID tag.

11. The reading apparatus according to claim 1, wherein the wireless tag is attached to a document.

12. The reading apparatus according to claim 1, further comprising:
a locking mechanism configured to hold the door closed when the antenna is emitting the radio wave.

13. A reading apparatus for reading a wireless tag, the reading apparatus comprising:
a housing having a chamber and an opening providing an entrance to the chamber;
a door attached to the housing and capable of covering the opening;
a first hole formed in the housing, the first hole being proximate to the door when the door is covering the opening;
a sensor attached to the housing and having at least a portion proximate to the first hole, the sensor configured to detect whether the door is open or closed;
an antenna inside the housing and configured to read information from wireless tags in the chamber by emitting a radio wave; and
a cover attached to the housing and covering the first hole and at least the portion of the sensor proximate to the first hole, the cover configured to block radio waves from passing through the first hole.

14. The reading apparatus according to claim 13, wherein the cover comprises at least one of a radio wave reflecting material and a radio wave absorbing material.

15. The reading apparatus according to claim 13, wherein
the cover includes a second hole therein, and
a wire connected to the sensor passes through the second hole.

16. The reading apparatus according to claim 15, further comprising:
a conductive material disposed in the second hole and filling a gap between the wire and the cover.

17. The reading apparatus according to claim 13, wherein
the sensor includes a mechanical switch,
the door includes a protrusion that depresses the mechanical switch through the first hole when the door is closed and releases the mechanical switch when the door is opened.

18. The reading apparatus according to claim 13, wherein
the sensor includes an optical sensor positioned to receive light through the first hole when the door is opened, and the door, when closed, substantially blocks light from outside of the housing from passing through the first hole and reaching the optical sensor when closed.

19. A reading apparatus for reading a wireless tag, the reading apparatus comprising:
a housing having a chamber and an opening providing an entrance to the chamber;
a door including a magnet and attached to the housing, the door being capable of covering the opening, the magnet being positioned so as to be proximate to a first portion of the housing when the door is closed and distal from the first portion when opened;
a magnetic sensor within the housing and attached to the first portion of the housing, the magnetic sensor configured to detect whether the door is opened or closed according to a detected proximity of the magnet relative to the magnetic sensor;
an antenna within the housing and configured to emit a radio wave to read wireless tags disposed in the chamber; and
a shielding portion comprising at least one of a radio wave absorbing material or a radio wave reflecting material covering the first portion of the housing.

20. The reading apparatus according to claim 19, wherein the shielding portion is a coating on a wall of the housing that is between the magnetic sensor and the magnet when the door is closed.
